(19) United States
(12) Patent Application Publication
(10) Pub. No.: US 2012/0080266 A1
(43) Pub. Date: Apr. 5, 2012

(54) MAST, LADDER, PLATFORM (MLP) ASSEMBLY AND METHOD

(76) Inventor: Jack Brock, Basehor, KS (US)

(21) Appl. No.: 13/071,090

(22) Filed: Mar. 24, 2011

Related U.S. Application Data
(60) Provisional application No. 61/389,048, filed on Oct. 1, 2010.

(51) Int. Cl. E06C 1/34; E04G 5/00; E04B 1/35; E06C 7/18

(52) U.S. Cl. 182/107; 182/115; 182/113; 52/745.18

(57) ABSTRACT

An MLP assembly and method for supporting and providing access to railroad signals. The MLP assembly may comprise a mast, one or more platform assemblies attached to the mast, and one or more ladders attachable to the mast and/or the platform assemblies. The MLP assembly may also comprise F-brackets and ladder supports for supporting the ladders relative to the mast. The MLP assembly may be placed in a folded configuration for transport thereof or an unfolded configuration for installation. The ladder supports and/or elements of the platform assemblies may rotate toward the mast into the folded configuration and may rotate away from the mast into the unfolded configuration. The MLP assembly may also comprise a plurality of stacking brackets configured for stacking a plurality of MLP assemblies on top of each other for transport to an installation site.

### RELATED APPLICATION

The present application is a nonprovisional patent application and claims priority benefit, with regard to all common subject matter, of earlier-filed U.S. provisional patent application titled, “Mast, Ladder, Platform (MLP) Assembly and Method”, Ser. No. 61/389,048, filed Oct. 1, 2010, incorporated by reference into the present document.

### BACKGROUND

1. Field

The present invention relates to an assembly for providing support and access to railroad or traffic signals.

2. Related Art

Mast ladder platform (MLP) assemblies are used to mount lights such as railroad signals at a desired height off of the ground and to provide repair and maintenance access to these lights. MLP assemblies typically comprise one or two platforms and two to four light fixtures attached to a pole or mast. Two light fixtures facing opposite directions are often mounted near a top end of the mast and another light fixture is mounted lower, in a mid-section of the mast facing the same direction as one of the light fixtures near the top end of the mast. A platform may extend from the mast proximate the light fixtures at the top end of the mast and/or a platform extending from the mid-section of the mast proximate its light fixture. A ladder may be fixed to the platforms to provide access thereto.

MLP assemblies are typically shipped on flatbed trucks with ladders and masts banded together and platforms welded together or crated in pieces and assembled at the site. Shipping of the MLP assemblies in this manner can be difficult because the different size crates, platforms, and poles limit the ability to stack the various components. Thus, only a few MLP assemblies may be shipped on a single flatbed truck.

Furthermore, once these MLP assemblies reach an installation site, they typically must be assembled on the ground by a crew of individuals. Weather conditions can greatly affect the ease or difficulty of assembly. For example, the platforms are typically secured to the masts with two U-bolts or straps. If the ground is snowy and/or muddy, these U-bolts or straps are difficult to attach to the masts because the masts may be laying in the snow or mud.

Moreover, the size and weight of the welded platforms typically necessitates several individuals to maneuver them onto the mast for assembly. The MLP assembly must then be lifted from the ground to an upright vertical position with a crane, and the masts have a tendency to roll relative to the size of a base of the MLP assembly during this lifting process. This rolling motion of such a large assembly can be dangerous to individuals installing the MLP assembly and standing nearby.

The rolling motion may be due in part to the ladder attached to the MLP assembly. The ladder is typically attached directly to the platforms prior to lifting the MLP assembly. However, in order to secure the ladder at the bottom thereof, the ladder is made longer than the mast and is attached to a ladder foundation buried in the ground. Because the ladder extends lower than the base of the MLP assembly, it is prone to bending under the weight of the MLP assembly during lifting to its vertical orientation. Furthermore, digging a hole for the ladder foundation takes additional time and labor.

The railroad signals attached to the MLP assemblies each may have a housing with access doors on the back. Since the doors are generically configured to only swing in one direction, at least one of the doors often collides with a top rail of its corresponding platform when opened. To solve this problem, it is know to remove a portion of the top rail of the platform to allow the access doors to open freely, but removal of a section of the top rail structurally weakens the railing and the platform.

Accordingly there is a need for an MLP assembly that overcomes the limitations of the prior art.

### SUMMARY

Embodiments of the present invention solve the above-mentioned problems and provide a distinct advance in the art of mast ladder platform (MLP) assemblies for support and maintenance of a railroad signal. An MLP assembly constructed in accordance with an embodiment of the invention may comprise a mast, one or more platform assemblies attached to the mast, and one or more ladders attached to the mast and/or the platform assemblies. The MLP assembly may also comprise a lower ladder support, a middle ladder support, and/or a plurality of F-brackets for attaching the ladders to the mast and/or the platform assemblies at a non-0° angle and a plurality of stacking brackets proximate a top end and a bottom end of the mast and configured to allow a plurality of MLP assemblies to be stacked one on top of another for transport.

The platform assemblies may each comprise a platform, a top rail, and a middle rail, each pivotable relative to the mast between a folded configuration and an unfolded configuration. Lower and/or middle ladder supports may also be pivotable between the folded configuration and the unfolded configuration. The MLP assembly may be transported in the folded configuration and then unfolded at the installation site. The platform, top rail, middle rail, and the ladder supports may have bolts added thereto in the unfolded configuration to prevent them from rotating back to the folded configuration. Furthermore, vertical supports may be bolted to the platform, top rail, and middle rail in the unfolded configuration.

At an installation site, the MLP assembly may rest on at least two of the stacking brackets in a horizontal orientation while the platform, top rail, middle rail, and ladder supports are unfolded. Then the MLP assembly may be reoriented from the horizontal orientation to a vertical orientation in which it is fixed to the ground and/or an installation surface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the preferred embodiments and the accompanying drawing figures.

### BRIEF DESCRIPTION OF THE DRAWINGS

Embodiments of the present invention are described in detail below with reference to the attached drawing figures, wherein:

FIG. 1 is a front perspective view of an MLP assembly constructed in accordance with an embodiment of the present invention and installed at an installation site in an unfolded configuration and in a vertical orientation;

FIG. 2 is a rear perspective view of the MLP assembly of FIG. 1;

FIG. 3 is a front perspective view of an alternative embodiment of the MLP assembly in which a middle platform assembly is replaced with a middle ladder support;

FIG. 4 is a fragmentary rear perspective view of the MLP of FIG. 3;

FIG. 5 is a perspective view of a mast of the MLP assembly of FIG. 1;

FIG. 6 is a front perspective view of a ladder assembly of the MLP assembly of FIG. 1;

FIG. 7 is a rear perspective view of the ladder assembly of FIG. 6;

FIG. 8 is a perspective view of the ladder assembly of FIG. 1 in a folded configuration and resting in a horizontal orientation;

FIG. 9 is a perspective view of a plurality of stacked MLP assemblies, each similar to the MLP assembly of FIG. 1;

FIG. 10 is a front top perspective view of the MLP assembly of FIG. 8 with a lower ladder support and a platform of the middle platform assembly each fixed in their respective unfolded configurations;

FIG. 11 is a fragmentary front bottom perspective view of the MLP assembly of FIG. 10;

FIG. 12 is a fragmentary front top perspective view of the MLP assembly of FIG. 10 with a platform of an upper platform assembly also fixed in its unfolded configuration;

FIG. 13 is a fragmentary front bottom perspective view of the MLP assembly of FIG. 10 with a top rail of the middle platform assembly fixed in its unfolded configuration;

FIG. 14 is a fragmentary front top perspective view of the MLP assembly of FIG. 13 with a middle rail of the middle platform assembly fixed in its unfolded configuration; and

FIG. 15 is a fragmentary front top perspective view of the MLP assembly of FIG. 14 illustrating one vertical support attached to the top rail, middle rail, and platform of the middle platform assembly and one vertical support still unattached from the middle platform assembly.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

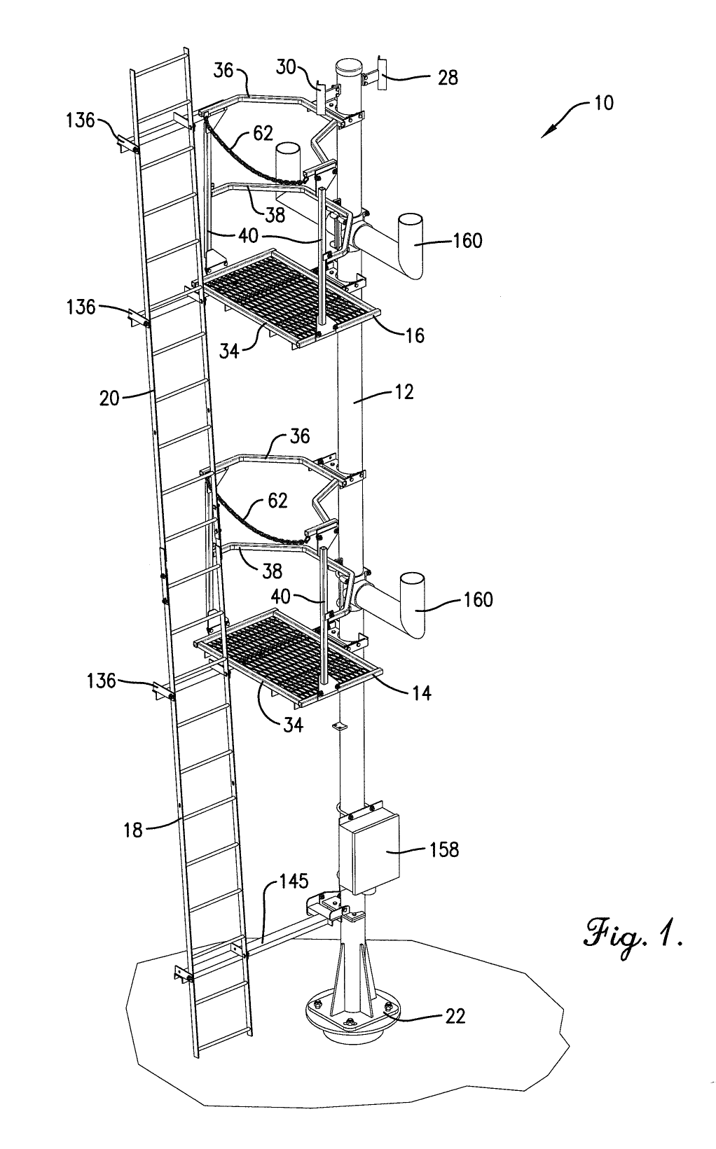

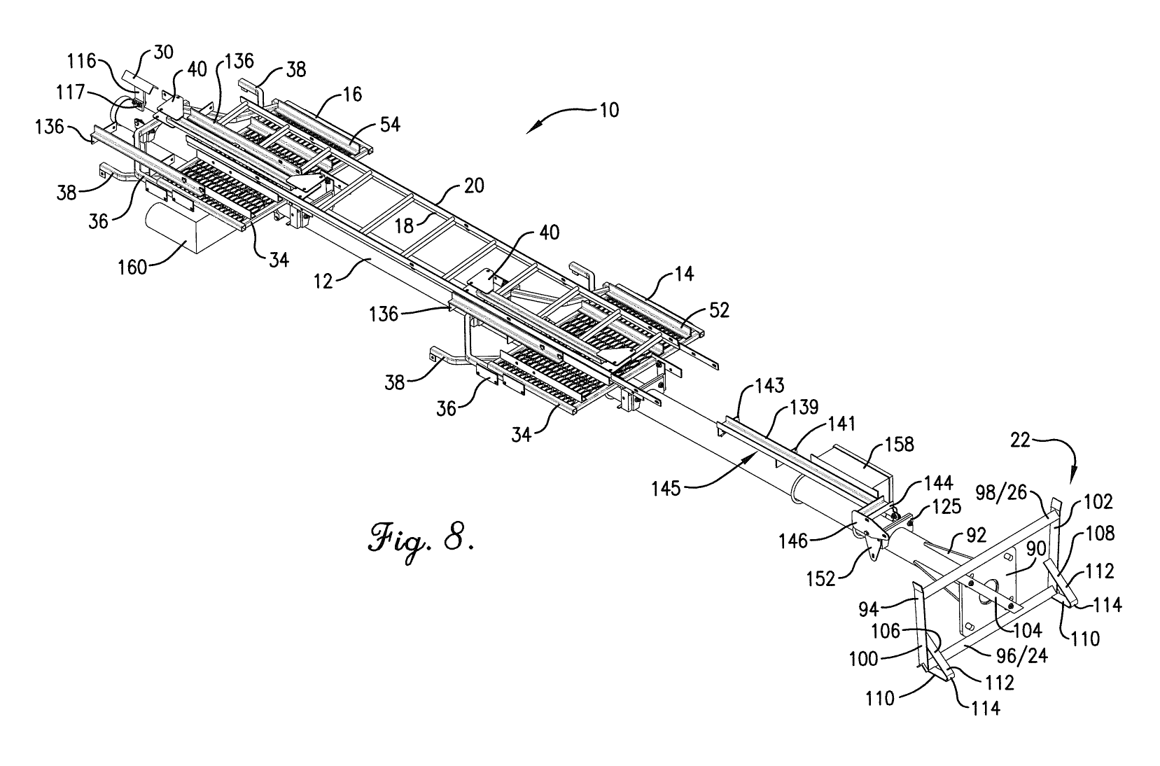

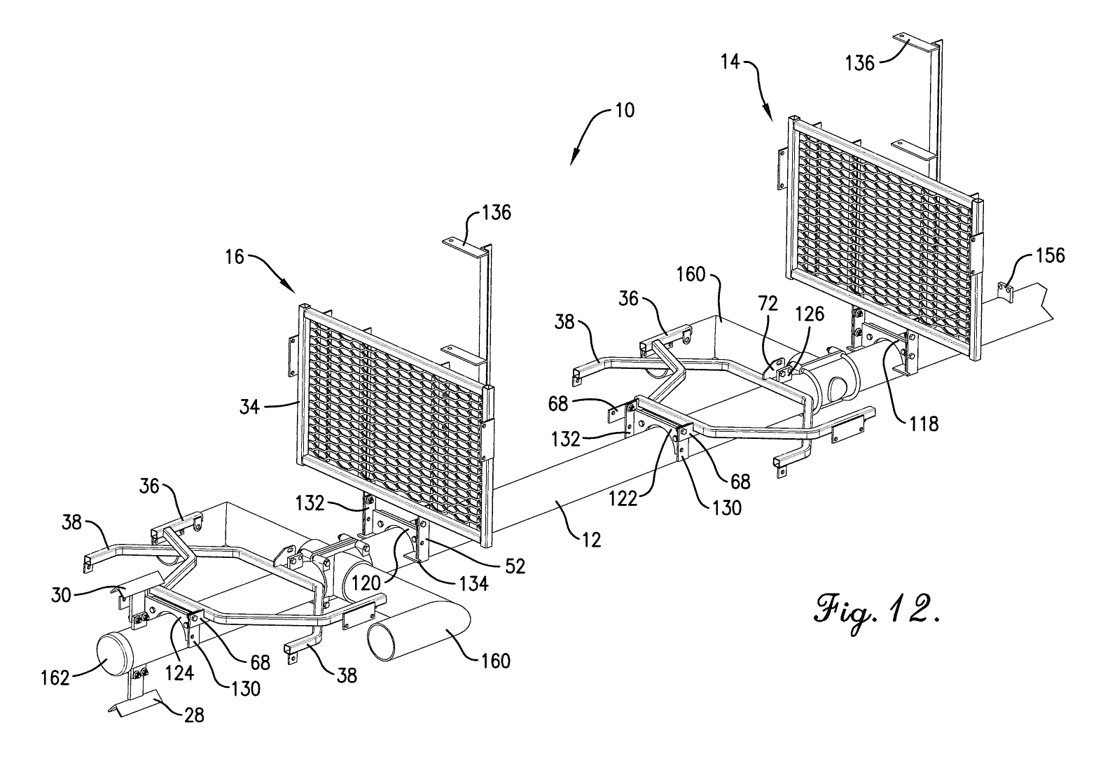

FIGS. 1-3 illustrate exemplary embodiments of a mast ladder platform (MLP) assembly 10 configured for supporting and providing maintenance access to one or more lights (not shown), such as railroad signals. The MPL assembly 10 broadly comprises a mast 12, one or more platform assemblies 14,16 attached to the mast 12, and at least one ladder 18,20 attached to the mast 12 and/or the platform assemblies 14,16. The MPL assembly 10 may further comprise a base 22 for fixing the mast 12 relative to the ground and one or more stacking brackets 24,26,28,30 for stacked transportation of a plurality of MPL assemblies, as further illustrated in FIGS. 8-14. Some embodiments of the MLP assembly 10 may also comprise a plurality of attachment components, ladder supports, and electrical housing components for housing various electrical circuits and/or wiring to be attached to the one or more lights, as later described herein.

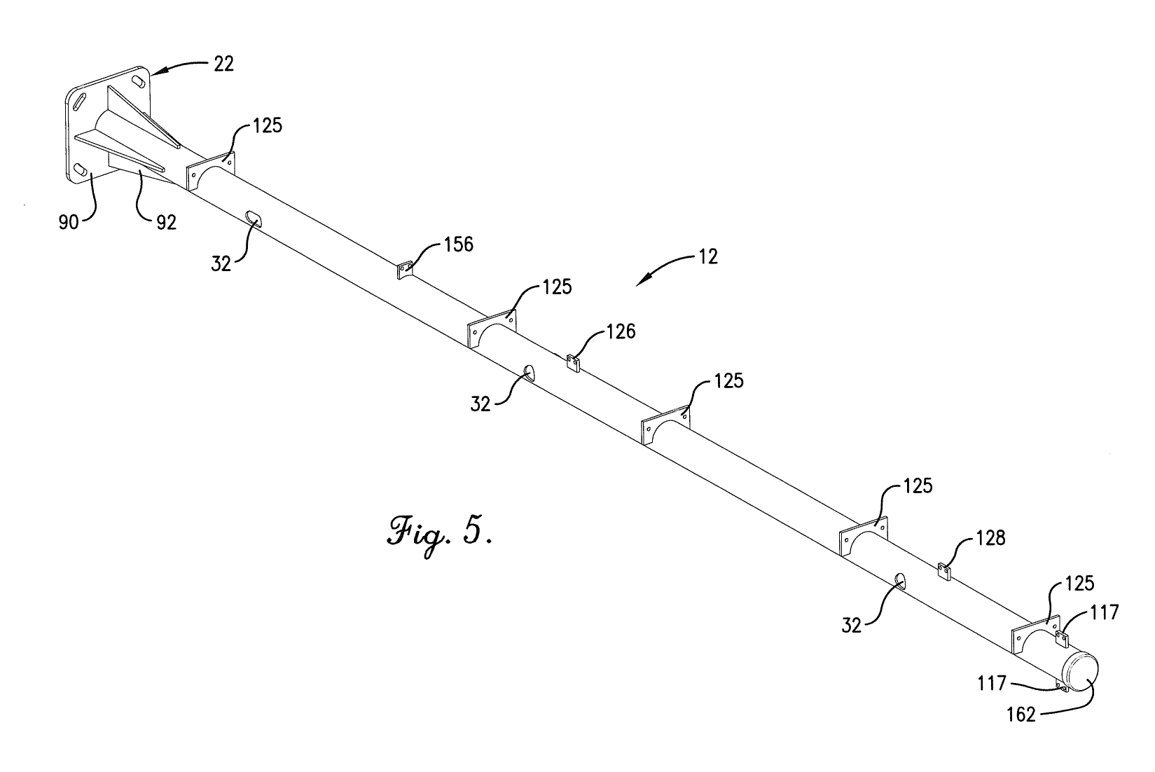

As illustrated in FIG. 5, the mast 12 may be a hollow elongated tube or pipe and may be made out of steel or any other suitable metal or hard, durable material. The mast may be welded or integrally formed with a plurality of the attachment components configured for supporting the platform assemblies 14,16 and/or the ladders 18,20. In some embodiments of the invention, the attachment components and/or various markings on the mast may include markings, registry features, or other guides to where various components should be attached. A plurality of holes 32 may be formed in the mast 12 through which electrical wires may extend.

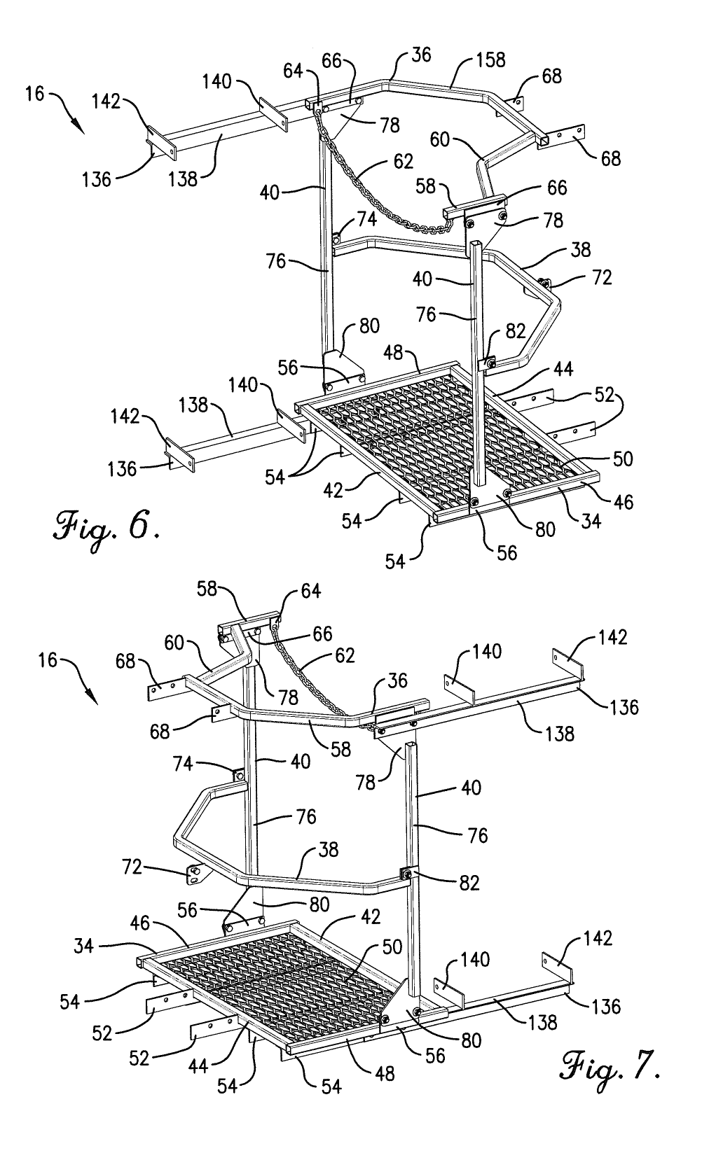

As illustrated in FIGS. 6-7, the platform assemblies 14,16 may be made from any combination of steel, other suitable metals, and other hard, durable materials known in the art. The platform assemblies 14,16 may include a middle platform assembly 14 and an upper platform assembly 16. Each of the platform assemblies 14,16 may comprise a platform 34, a top rail 36, a middle rail 38, and one or more vertical supports 40.

The platform 34 may comprise a plurality of platform rails 42,44,46,48 which may be made of hollow tubes having a square, rectangular, circular, triangular, or any other cross-sectional shape. For example, four elongated platform tubes having a hollow, square-shaped cross-section may be arranged into a square or rectangle to form a periphery of the platform 34. In this configuration, there may be a front platform rail 42, a back platform rail 44, and two side platform rails 46,48. The platform rails 42-48 may be bolted together, welded together, or integrally formed as a single monolithic piece.

In an alternative embodiment, the platform rails may be angle or angle rails. Angle or angle rail, as used herein, may be defined as an elongated rail with an L-shaped cross-section or two elongated straps forming right degree angles with each other down the length thereof. Straps or strips, as used herein, may be defined as rigid, elongated, substantially flat components which may be substantially rectangular. Angle, angle rails, straps, and strips as used herein may be made of steel, metal, or any other rigid, durable material.

The platform 34 may also comprise a platform grate 50 positioned between and attached to the platform rails 42-48 and arranged in any configuration or pattern required to allow a person to stand thereon. The platform grate 50 may be bolted to, welded to, or integrally formed with the platform rails 42-48.

The platform 34 may further comprise pivotable straps 52, platform support angles 54, and vertical support attachment straps 56. The pivotable straps 52 may be substantially flat, rigid steel straps bolted to, welded to, or otherwise integrally formed with another component of the platform 34, such as the platform rails 42-48. The pivotable straps 52 may be fixedly attached to and extend from the back platform rail 44 at a substantially perpendicular angle relative to the length of the platform rail 44. In some embodiments of the MLP assembly 10, two pivotable straps 52 spaced apart from each other and perpendicular with each other may be provided. The pivotable straps 52 of the platform 34 may also each have a notch having a right angle formed therein, such that one edge formed by the notch can be welded to a first side of the back platform rail 44, and the other edge formed by the notch can be welded to a second side of the back platform rail 44 that is adjacent to the first side, as illustrated in FIG. 7.

The pivotable straps 52 may have holes formed therethrough such that a bolt or any other mechanical attachment may extend therethrough to fixedly and/or pivotally attach the pivotable straps 52 to the mast 12. For example, the pivotable straps 52 may rotate about a bolt in order to actuate the platform 34 from a folded position to an unfolded position and vice versa. In the folded position, the platform 34 is substantially parallel with an axis of the mast 12, and in the unfolded position, the platform 34 is substantially perpendicular with the axis of the mast 12, as later described herein.

The platform support angles 54 may extend across the platform grate 50 and/or may extend from the front platform rail 42 to the back platform rail 44 and may be arranged substantially parallel with the side platform rails 46,48. The platform support angles 54 may be bolted to, welded to, and/or integrally formed with one or more of the platform rails 42-48 and the platform grate 50. The platform support angles 54 may be made of angles or angle rails and may provide additional support underneath the platform grate 50 when an individual is standing thereon. In some embodiments of the MLP assembly 10, there may be two or more platform support angles 54 substantially equally spaced apart from each other or spaced in any manner desired to provide a desired load distribution. At least a portion of the platform support angles 54 may have holes formed therein for attachment of ladder supports, as later described herein.

The vertical support attachment straps 56 of the platform 34 may be fixed to the side platform rails 46,48 and may comprise one or more holes formed therethrough for attachment to at least one of the vertical supports 40. The holes may be sized and configured to receive bolts therethrough. The vertical support attachment straps 56 may be bolted to, welded to, or otherwise integrally formed with the side platform rails 46,48. Alternatively, one or more vertical support attachment holes may be formed directly into at least one of the side platform rails 46,48 and configured for providing attachment to at least one of the vertical supports 40.

The top rail 36 may be made of hollow tubes, which may be square, rectangular, circular, triangular, or any cross-sectional shape. The top rail 36 may have an outward-curving portion 58 and an inward-curving portion 60. The outward-curving portion 58 of the top rail 36 may be curved or angled outward and substantially away from an individual standing on the platform 34. The inward-curved portion 60 of the top rail 36 may be curved or angled inwards to provide clearance for a light box or signal box door (not shown) to open in a direction toward the top rail 36. The top rail 36 may extend approximately 180° around an individual on the platform 34, with a safety chain 62 attachable between two ends of the top rail 36.

The safety chain 62 may be a chain, rope, door, pivotable gate, or any other apparatus configured to, along with the top rail's outward- and inward-curving portions 58,60, cooperatively form a 360° boundary around an individual standing on the platform 34. Furthermore, the top rail 36 may comprise safety chain tabs 64 having holes formed therein through which the safety chain may be linked. The safety chain tabs 64 may be bolted to, welded to, or integrally formed with the top rail 36.

The top rail 36 may also comprise or be attached to vertical support attachment straps 66, which may have holes formed therethrough for attachment to the vertical supports 40. The holes in the vertical support attachment straps 66 on the top rail 36 may be laterally and/or vertically aligned with the holes formed in the vertical support attachment straps 56 of the platform 34. The vertical support attachment straps 66 may each be bolted to, welded to, or integrally formed with the outward-curving portion 58 of the top rail 36. Alternatively, one or more vertical support attachment holes may be formed directly into the outward-curving portion 58 of the top rail 36 and configured for providing attachment to at least one of the vertical supports 40. The holes may be sized and configured to receive bolts therethrough.

The top rail 36 may also comprise or be fixedly attached to pivotable straps 68 which may have holes formed therethrough for attachment to the mast 12. The pivotable straps 68 of the top rail 36 may be bolted to, welded to, or otherwise integrally formed with the top rail 36. The pivotable straps 68 of the top rail 36 may be laterally aligned with the pivotable straps 52 of the platform 34. The pivotable straps 68 of the top rail 36 may comprise a pair of pivotable straps which may be identical in length or may have differing lengths from each other. For example, making one of the pivotable straps 68 of the top rail 36 shorter than the other may allow the top rail to be pivoted about a bolt to the folded position without interfering with or colliding with other components.

The pivotable straps 68 of the top rail 36 may require at least two attachment holes or alternatively only one attachment hole formed therethrough. The pivotable straps 68 of the top rail 36 may also each have a notch having a right angle formed therein, such that one edge formed by the notch can be welded to a first side of the hollow top rail 36, and the other edge formed by the notch can be welded to a second side of the hollow top rail 36 that is adjacent to the first side, as illustrated in FIG. 7.

The middle rail 38 of at least one of the platform assemblies 14,16 may be made of hollow tubes, which may be square, rectangular, circular, triangular, or any cross-sectional shape. The middle rail 38 may be curved outward continuously or at given length intervals to extend approximately 180° around an individual standing on the platform 34. The middle rail 38 may further comprise or be fixedly attached to at least one mast attachment tab 72, which may have at least one hole formed therethrough for pivotable or fixed attachment to the mast 12, as described below. The middle rail 38 may be bolted to, welded to, or integrally formed with the mast attachment tab 72. The middle rail 38 may also comprise or be fixedly attached to one or more vertical support attachment plates 74. The vertical support attachment plates 74 of the middle rail 38 may be configured to attach to one of the vertical supports 40 at a point between the platform 34 and the top rail 36.

The vertical supports 40 may each comprise a primary support rail 76, an upper vertical support plate 78, a lower vertical support plate 80, and a middle rail attachment tab 82. The primary support rail 76 may be made of hollow tubes, which may be square, rectangular, circular, triangular, or any cross-sectional shape. The lower and upper vertical support plates 78,80 may be bolted to, welded to, or integrally formed with the primary support rail 76 proximate opposite ends thereof. The lower and upper vertical support plates 78,80 may each comprise two holes formed therethrough such that bolts or other mechanical attachments may extend therethrough to attach the vertical supports 40 to the vertical support attachment straps 56 of the platform 34 and the vertical support attachment straps 66 of the top rail 36, respectively. The middle rail attachment tab 82 of each of the vertical supports 40 may have at least one hole formed therethrough, configured to allow bolts or other mechanical attachments to extend therethrough to be couple with one of the vertical support attachment plates 74 of the middle rail 38.

The ladders 18,20 may each comprise a plurality of rungs 84 and two rung supports 86,88 attached at opposite ends of each of the rungs 84, such that the rungs are spaced apart and parallel with each other. The ladders 18,20 may be two bolted together to form a single ladder. The ladders 18,20 may be attached via various mechanical attachments, as described below, to the mast 12 at an angle between 0° and 90°. Specifically, the ladders 18,20 may be fixed to the mast 12 at an angle between 2° and 10°. For example, the ladders may be fixed to the mast 12 at an approximately 5° angle, as illustrated in FIGS. 1-3. In some embodiments of the invention, when the mast 12 is substantially vertical in relationship with the ground and the ladders 18,20 are mounted to the mast 12, a bottom end of the ladders 18,20 does not extend any lower than the base 22 of the MLP assembly 10.

In some embodiments of the MLP assembly 10, an optional bottom ladder support (not shown) may be bolted proximate a bottom-most rung of the ladders 18,20 relative to the ground and may have a portion thereof configured to be buried in the ground when the mast 12 is vertically oriented and the base 22 is fixed relative to the ground. This ladder configuration is advantageous because it allows the base to make contact with the ground first when the MLP assembly 10 is raised from a horizontal orientation to a vertical orientation, as opposed to a ladder contacting the ground first as the MLP assembly 10 is tipped up from its horizontal to its vertical orientation.

The base 22 may comprise a base plate 90, mast-supporting gussets 92, and a temporary base frame 94, as illustrated in FIG. 8. The base plate 90 may be substantially square, circular, rectangular, triangular, or any shape desired. In one embodiment of the base 22, the base plate 90 is square with four rounded corners. The base plate 90 may be welded to, bolted to, and/or integrally formed with the mast 12 at or proximate a bottom end thereof. For example, an approximately mast-sized hole may be formed through a center of the base plate 90 and the mast 12 may be welded to the base plate 90 at the periphery of the mast-sized hole. Furthermore, fastening holes or slots may be formed through the base plate 90 such that mechanical fasteners may be inserted therethrough for securing the base 90 to the ground or another mounting surface.

The mast-supporting gussets 92 may be welded to, bolted to, and/or integrally formed with the base plate 90 and/or the mast 12. The mast-supporting gussets 92 may be substantially triangular in shape, with a first edge attached to the base plate 90 and a second edge attached to the mast 12. In some embodiments, the gussets form right triangles, and a tangent edge of each mast-supporting gusset 92 faces away from the base plate 90 and the mast 12. For example, there may be 4 mast-supporting gussets 92 arranged in 90° angles relative to each other around the mast 12 and 90° angles relative to base plate 90.

The temporary base frame 94 may be configured to provide efficient transporting and re-orienting of the MLP assembly 10, but may be removed before the base plate 90 is fixedly attached to the ground or any other mounting surface. As illustrated in FIG. 8, the temporary base frame 94 may comprise at least four elongated temporary base frame pieces 96,98,100,102, at least one diagonal support strip 104, and at least two rocker straps 106,108. The temporary base frame pieces 96-102 may be attached together in a square or rectangular configuration in such a manner as to provide a wider base for the MLP assembly 10 than the base plate 90 provides. This is particularly useful when the MLP assembly 10 is re-orientated from the horizontal to the vertical orientation. In some embodiments of the MLP assembly 10, the diagonal support strip 104 is attached to at least two of the temporary base frame pieces 96-102 and mechanically attached to the base plate 90 in one or more locations.

The rocker straps 106,108 may be configured to allow the MLP assembly 10 to rock or pivot thereon when re-oriented from the horizontal to the vertical orientation. The rocker straps 106,108 may be substantially V-shaped with a first portion 110 extending at a 90° angle from at least one of the temporary base frame pieces 96-102, a second portion 112 forming a less-than-90° angle with the first portion, and a curved corner portion 114 or radiused corner portion extending between the first and second portions 110,112. When the mast 12 is raised from a substantially horizontal orientation up to a vertical orientation relative to the ground, the mast 12 may rock or pivot on the curved or radiused corner portion 114 of the rocker straps 106,108 to gradually guide the mast 12 to its upright horizontal orientation. In other embodiments, the rocker straps may be substantially J-shaped, with the first portion 110 being shorter than the second portion 112. The curved or radiused corner portion 114 may have any radius desired. The rocker straps 106,108 may be spaced apart at or proximate to opposing ends of one of the temporary base frame pieces 96-102.

The temporary base frame pieces 96,98 may also serve as the stacking brackets 24,26 of the MLP assembly 10. For example, a first temporary base frame piece 96 may also be a first base stacking bracket 24 and a second temporary base frame piece 98 may also be a second base stacking bracket 26. The other two temporary base frame pieces 100,102 may be substantially rigid straps each have a first end with a notch formed therein for mating with and/or being welded to the first stacking bracket 24, and a second end extending past a point at which ends of the second stacking bracket 26 are welded to the temporary base frame pieces 100,102. In some embodiments of the invention, the second ends of the temporary base frame pieces 100,102 may angle away from each other to help orient the second stacking bracket 26 of another MLP assembly being stacked thereon.

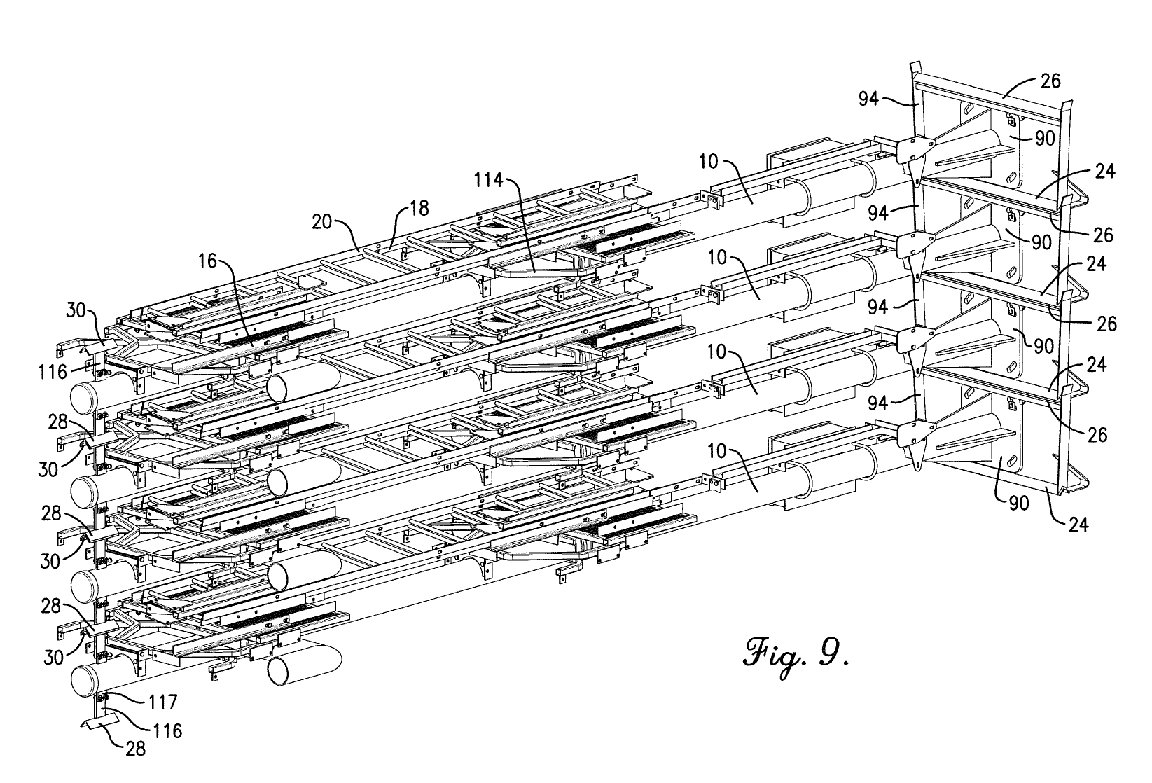

The stacking brackets 24-30, as illustrated in FIGS. 8-9 may also comprise a first top stacking bracket 28 and a second top stacking bracket 30. One or more of the stacking brackets 24-30 may further comprise and/or attach to bracket extensions 116 extending between the stacking brackets 24-30 and the mast 12 to create a desired amount of separation between stacked MLP assemblies.

The first base stacking bracket 24 and the first top stacking bracket 28 may each comprise elongated, substantially V-shaped channels angled away from a center axis of the mast 12. The second base stacking bracket 26 and the second top stacking bracket 30 may each comprise elongated, substantially V-shaped channels angled toward the center axis of the mast 12. The first base stacking bracket 24 and the second base stacking bracket 26 may be positioned substantially perpendicular with the center axis of the mast. The first top stacking bracket 28 and the second top stacking bracket 30 may be positioned substantially parallel with the center axis of the mast.

The bracket extensions 116 attached to the first and second top stacking brackets 28,30 may extend between the first top stacking bracket 28 and the mast 12 and between the second top stacking bracket 30 and the mast 12, respectively. For example, one end of the bracket extensions 116 may be bolted to, welded to, and/or integrally formed with the stacking brackets 28,30 and an opposing end of the bracket extensions 116 may be bolted to, welded to, or integrally formed with bracket tabs 117 extending outward from the mast 12 proximate a top end of the mast 12. The bracket tabs 117 may be bolted to, welded to, or integrally formed with the mast 12. Alternatively, the bracket tabs 117 may be formed together with each other as a single integral piece, forming an integral top bracket tab (not shown) which may extend through two radially-aligned openings or holes formed proximate a top end of the mast 12. Then the integral top bracket tab may be welded thereto and the first and second top brackets 28,30 and/or the bracket extensions 116 may be welded to ends of the integral top bracket tab.

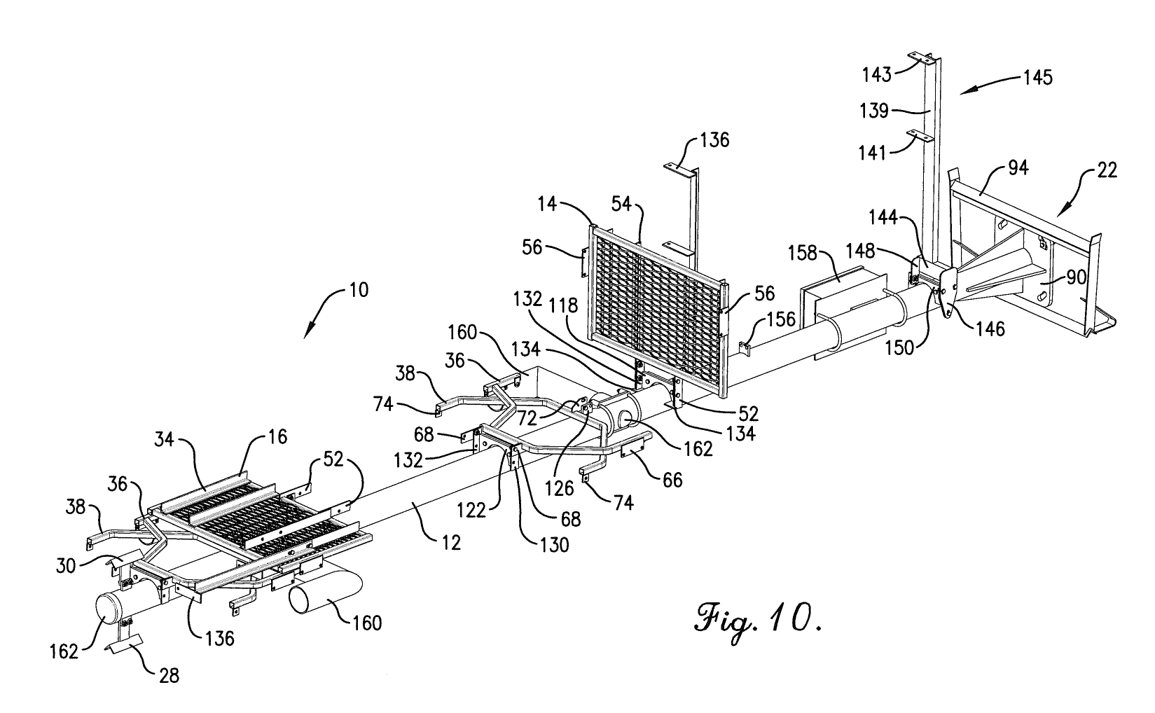

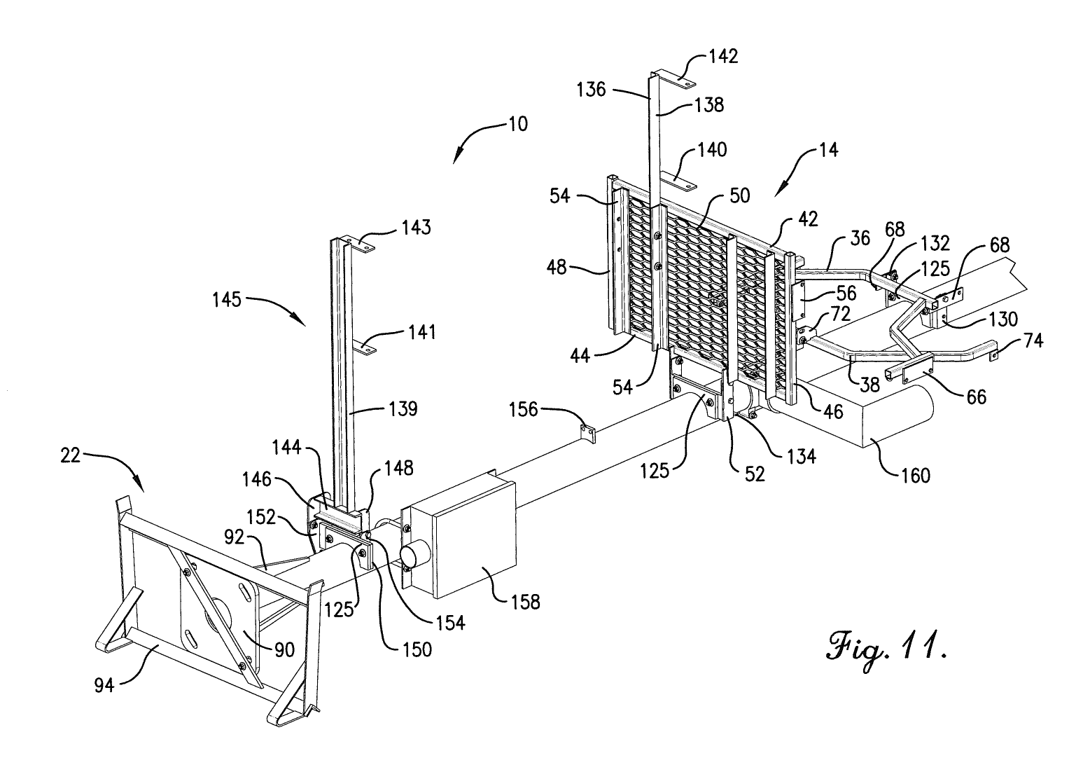

Various attachment components may be integrally formed to, welded to, or bolted to the mast 12 to attach the ladders 18,20 and the platform assemblies 14,16 thereto. For example, as illustrated in FIGS. 10-12, attachment components for attaching the platform assemblies 14,16 to the mast 12 may include platform-mast attachment plates 118,120, top rail-mast attachment plates 122,124, and middle rail-mast attachment tabs 126,128, each of which may be bolted to, welded to, or integrally formed with the mast 12.

In some embodiments of the invention, the mast 12 may have mast attachment plates 125 welded or integrally formed thereto and extending at a substantially 90° angle relative to the center axis of the mast 12, as illustrated in FIG. 5. The mast attachment plates 125 may have holes formed therethrough such that the platform-mast attachment plates 118,120 and the top rail-mast attachment plates 122,124 may mate with and be bolted to the mast attachment plates 125. The mast attachment plates 125 may each be substantially square or rectangular with an arch or half-circle-shaped notch cut into one side edge thereof for mating with the mast 12 and be welded thereto.

The platform-mast attachment plates 118,120 and the top rail-mast attachment plates 122,124 may also each be substantially square or rectangular with an arch or half-circle-shaped notch cut into one side edge thereof for mating with the mast 12. The plates 118-124 may each be substantially perpendicular relative to the center axis of the mast 12. Each of the plates 118-124 may comprise or be attached to first and second mast attachment straps 130,132. The first and second mast attachment straps 130,132 may be bolted to, welded to, or integrally formed with each of the plates 118-124 on opposing edges thereof.

One or two pairs of the first and second mast attachment straps 130,132 attached to the platform-mast attachment plates 118,120 may have one or more holes formed therethrough for attachment to the pivotable straps 52 of the platform 34. One or two other pairs of the first and second mast attachment straps 130,132 attached to the top rail-mast attachment plates 122,124 may have one or more holes formed therethrough for attachment to the pivotable straps 68 of the top rail 36. For example, the holes may be sized to allow bolts to extend therethrough for attachment.

The platform-mast attachment plates 118,120 may also comprise or be attached to one or more pivot limiting tabs 134. The pivot limiting tabs 134 may be bolted to, welded to, or integrally formed with the platform-mast attachment plates 118,120 and/or their corresponding first and second mast attachment straps 130,132, and may be positioned to impede a rotational path of the pivotable straps 52 of the platform 34. Specifically, the pivot limiting tabs 134 may prevent the platform 34 from unfolding greater than or rotating greater than 90° relative to the center axis of the mast 12.

The middle rail-mast attachment tabs 126,128 may each be bolted to, welded to, or integrally formed with the mast 12, protruding in a radial direction therefrom. Furthermore, the middle rail-mast attachment tabs 126,128 may each have a small length oriented substantially parallel with the center axis of the mast 12. The middle rail-mast attachment tabs 126,128 may each have one or two holes formed therein such that a mechanical fastener may extend therethrough to fixedly and/or rotatably couple the middle rail-mast attachment tabs 126,128 with the mast attachment tabs 72 of the middle rails 38.

The MLP assembly 10 may include a plurality of components for supporting the ladders 18,20. Specifically, the MPL assembly 10 may comprise one or more F-brackets 136 each having a first elongated rail 138 and two parallel, rigid attachment strips 140,142 bolted to, welded to, or integrally formed with the first elongated rail 138. The first elongated rail 138 may be an angle rail. The two attachment strips 140,142 may be attached perpendicular to the first elongated rail 138 and may have one or more holes formed therein. The attachment strips 140,142 may be spaced apart by a distance approximately equal to a width of the ladders 18,20, such that mechanical attachments may be inserted through the attachment strips 140,142 and the ladder rung supports 86,88 to fixedly couple the F-brackets 136 and the ladders 18,20 together.

The first elongated rail 138 of at least some of the F-brackets 136 may be bolted to, welded to, or integrally formed with the platform support angles 54 of the platform 34. For example, the first elongated rail 138 of one of the F-brackets 136 may be fixed to a first one of the platform support angles 54 on the middle platform assembly 14 and the first elongated rail 138 of another one of the F-brackets 136 may be fixed to a second one of the platform support angles 54 on the upper platform assembly 16. The first one of the platform support angles 54 and the second one of the platform support angles 54 may be purposely positioned in vertical misalignment to allow the ladders 18,20 to be mounted at a non-0° angle, such as a 5° angle, relative to the center axis of the mast 12. For example, the first one of the platform support angles 54 may be more closely located to a center point of the platform 34 than the second one of the platform angles 54. In some embodiments of the invention, the top rail 36 of the upper platform assembly 16 and/or one of the upper vertical support plates 80 thereof may be attached to one of the F-brackets 136 to provide additional support proximate a top end of the ladder 18,20.

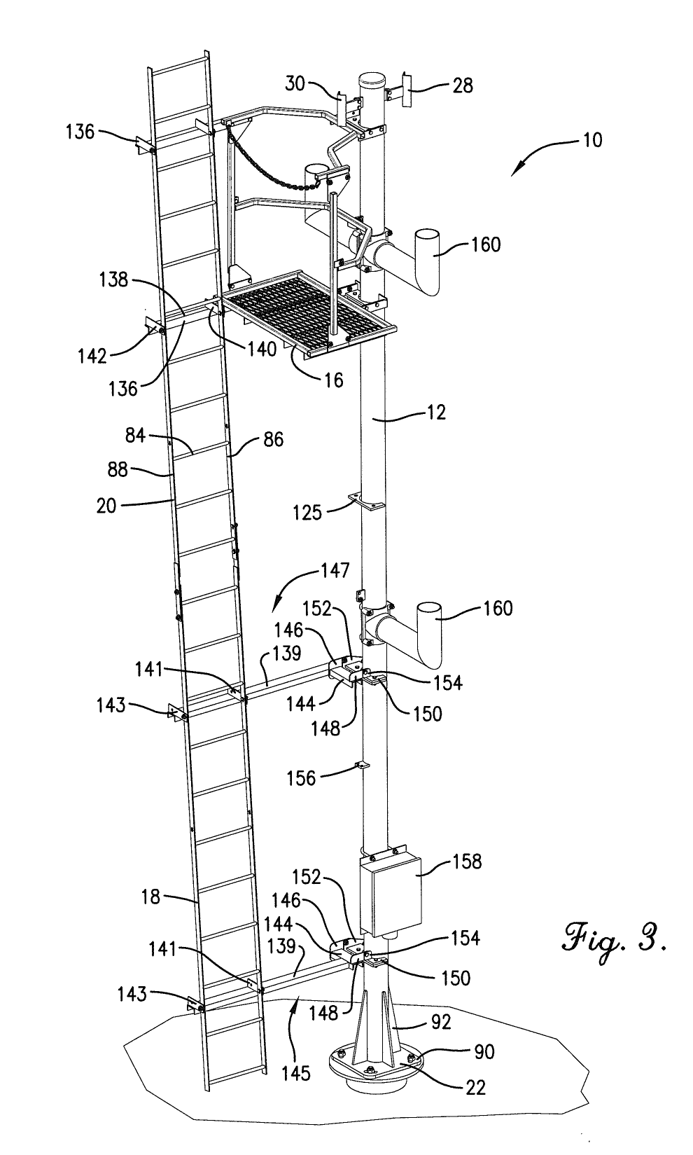

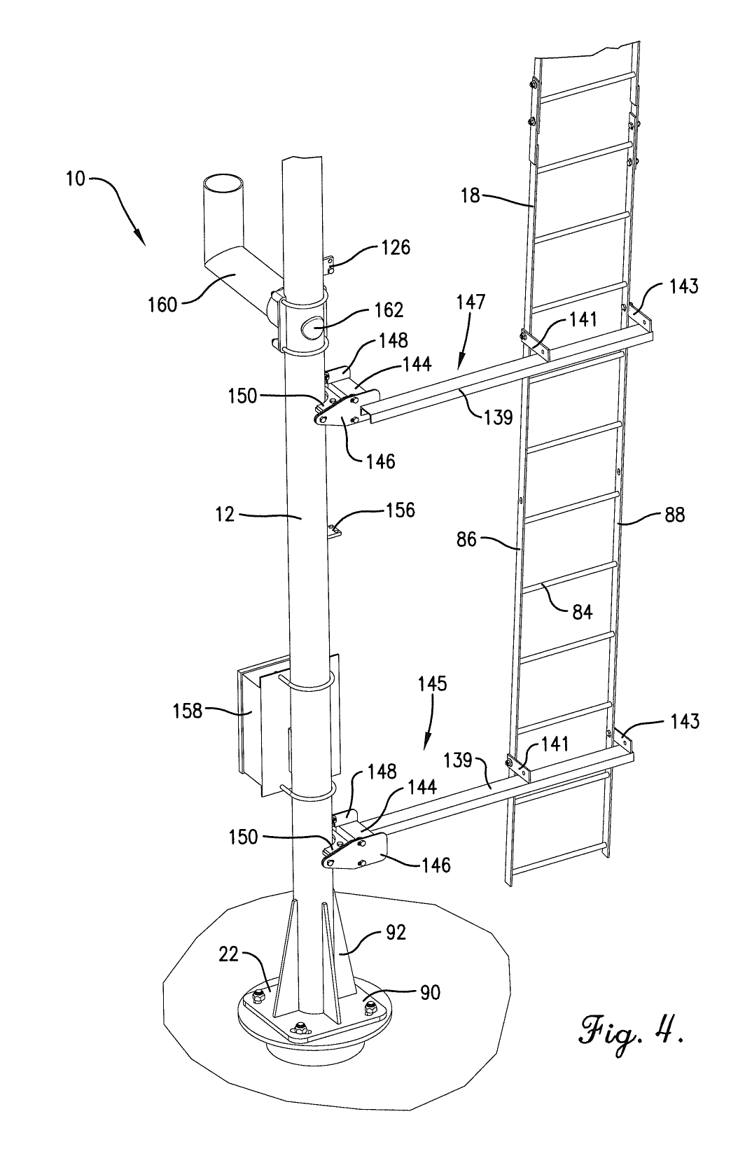

The MLP assembly 10 may also comprise a lower ladder support 145 and/or a middle ladder support 147 which may be attached directly to the mast 12 via a plurality of attachment components. The lower ladder support 145 may be attached to the mast 12 proximate the base. In some embodiments of the invention, as illustrated in FIGS. 3-4, the middle platform assembly 14 may be omitted and replaced with the middle ladder support 147 in a configuration similar to that described below for the lower ladder support 145.

The lower ladder support 145, and/or the middle ladder support 147, may each comprise a first elongated channel 139 and two parallel, rigid attachment strips 141,143 bolted to, welded to, or integrally formed with the first elongated channel 139. The first elongated channel 139 may be an elongated rail having three adjacent sides arranged at right degree angles relative to each other. The two attachment strips 141,143 may be attached perpendicular to the first elongated channel 139 and may have one or more holes formed therein. The attachment strips 141,143 may be spaced apart by a distance approximately equal to a width of the ladders 18,20, such that mechanical attachments may be inserted through the attachment strips 141,143 and the ladder rung supports 86,88 to fixedly couple the lower ladder support 145 and the ladders 18,20 and/or the middle ladder support 147 and the ladders 18,20.

The lower ladder support 145, and/or the middle ladder support 147 may also each comprise a second elongated channel 144 attached perpendicularly relative to the first elongated channel 139. The second elongated channel 144 may also comprise or be welded to a first mast attachment plate 146 and a second mast attachment plate 148 at opposing ends of the second elongated channel 144. The first and second mast attachment plates 146,148 may both comprise one or more holes therein and may be pivotally and/or fixedly attached relative to the mast 12 via bolts or other mechanical attachments. The first elongated channel 139 may be welded or attached to the second elongated channel 144 at different locations for the middle ladder support 147 than the lower ladder support 145, as illustrated in FIGS. 3-4. This allows these ladder supports 145,147 to extend at different distances to create a non-0° tilt of the ladders 18,20. For example, the lower ladder support 145 may have an end of the first elongated channel 139 welded directly to a side of the second elongated channel 144 between its opposing ends at a perpendicular angle, while the middle ladder support 147 in FIGS. 3-4 may have a side of the first elongated channel 139 welded directly to an outer face of the first mast attachment plate 146.

A ladder support attachment plate 150 may be bolted to, welded to, or integrally formed with the mast 12. For example, the ladder support attachment plate 150 may have holes formed therethrough to be bolted to one of the welded mast attachment plates 125 extending perpendicularly from the mast 12. The ladder support attachment plate 150 may have an arched or circular notch formed therein, similar to the platform-mast attachment plates 118,120 and the top rail-mast attachment plates 122,124. Furthermore, a first ladder support plate 152 and a second ladder support plate 154 may be bolted to, welded to, or integrally formed with the ladder support attachment plate 150.

The first mast attachment plate 146 may be fixedly and/or pivotally bolted to the first ladder support plate 152 and the second mast attachment plate 148 may be fixedly and/or pivotally bolted to the second ladder support plate 154. In one embodiment of the invention, both the first mast attachment plate 146 and the first ladder support plate 152 may have three holes spaced in a substantially triangular configuration through which bolts or other mechanical attachments may extend. The second mast attachment plate 148 and the second ladder support plate 154 may each have at least one hole through which bolts or other mechanical attachments may extend. In some embodiments of the invention, at least a portion of both the second mast attachment plate 148 and the second ladder support plate 154 may be positioned closer to the mast 12 than either the first mast attachment plate 146 or the first ladder support plate 152.

The lengths of the first and second mast attachment plates 146,148 may be greater than lengths of the first and second ladder support plates 152,154 respectively, such that the added length of the mast attachment plates 146,148 may provide surfaces to which the second elongated channel 144 may be welded or otherwise attached. Having shorter lengths for the first and second ladder support plates 152,154 also provides clearance for the second elongated channel 144 when the lower ladder support 145 and/or the middle ladder support 147 are actuated from a folded configuration to an unfolded configuration.

In some embodiments of the invention, the mast 12 may have at least one retaining tab 156 bolted to, welded to, or integrally formed with the mast 12 and configured for securing the lower ladder support 145 in a folded configuration. For example, the retaining tab 156 may extend perpendicular to the central axis of the mast 12 and may comprise one or more holes formed therethough. When the lower ladder support 145 is folded or pivoted toward the mast 12, at least one of its two attachment strips 140,142 may be attached to the retaining tab 156 via one or more bolts or other mechanical attachments. Similarly, the middle ladder support 145 may be mechanically attached to one of the mast attachment plates 125 in its folded configuration and then unattached therefrom to be placed in its unfolded configuration.

As mentioned above, the MPL assembly 10 may also comprise various electrical housing components, as illustrated in FIGS. 1-3, for housing various electrical circuits and/or wiring to be attached to the one or more lights. For example, the MLP assembly 10 may comprise an electrical box 158, wire conduits 160, and a signal box (now shown). The electrical box 158 may be welded and/or mechanically joined with the mast 12 proximate the base 22 thereof and may allow for connection to an external electrical source. Wires may extend from the electrical box 158 through one of the plurality of holes 32 formed in the mast 12 and may then be threaded through the wire conduits 160.

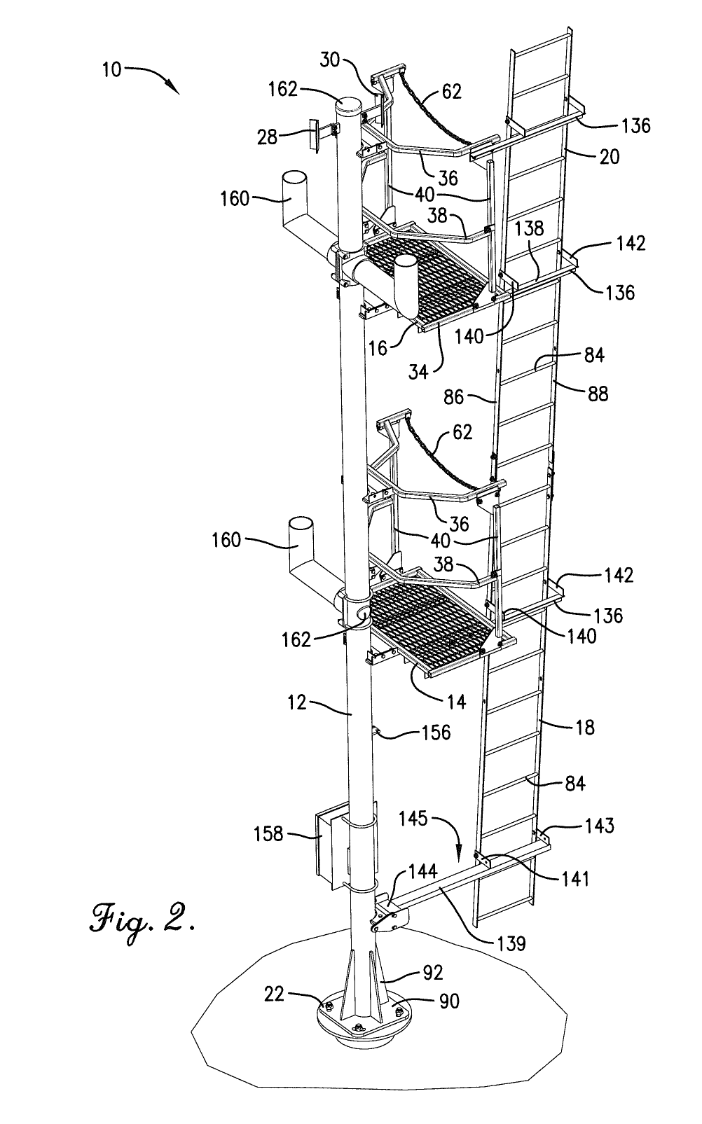

The wire conduits 160 may have an open end formed integrally to or welded to the mast 12 at one of the holes 32 formed in the mast 12 such that wires may extend from the electrical box 158 or signal box through at least a portion of the mast 12, then out of the mast 12 directly into the wire conduits 160. The wires extending through the wire conduits 160 may enter the signal box to be electrically coupled to wires or electrical components therein. For example, the wires extending out of the wire conduits 160 may attach to one or more lights in the signal box. Any openings or holes 32 of the MLP assembly 10 not utilized may be covered with a plug 162 or any suitable cover to keep water and animals out of the mast 12, as illustrated in FIG. 2.

A method for shipping and installing the MLP assembly 10 may comprise stacking a plurality of MLP assemblies in a folded configuration and a substantially horizontal orientation, as illustrated in FIG. 8, such that at least some of the stacking brackets 24-30 of one MLP assembly engage with at least some of the stacking brackets 24-30 of another MLP assembly, as illustrated in FIG. 9. The one or more MLP assemblies may then be transported via automobile, train, boat, etc. Once the MLP assemblies reach an installation site, the desired MLP assembly 10 or a top one of the MLP assemblies may be removed from the vehicle and placed horizontally on the ground or an installation surface. The components of the MLP assembly 10 may be unfolded into and/or bolted into an unfolded configuration. Then the MLP assembly 10 may then be actuated into an upright, substantially vertical orientation. The temporary base frame 94 may then be removed and the base plate 90 may be secured to a desired location, such as the ground or another base secured to the ground, as illustrated in FIGS. 1-4.

In some embodiments of the folded configuration, as illustrated in FIGS. 8-9, the ladders 18,20, at least one of the F-brackets 136, and/or the vertical supports 40 may not be bolted to other components of the MLP assembly 10, but rather are banded to the MLP assembly 10 with any sort of strong cords or rope known in the art to bundle a plurality of stacked components together. The middle rails 38 may be pivoted about a single bolt in a direction away from the base 22 to be placed into the folded configuration illustrated in FIG. 8 and may be pivoted about that same single bolt in a direction toward the base 22 to be placed in the unfolded configuration.

The top rails 36 may be pivoted about two bolts, one extending through each of the pivotable straps 68 of the top rails 26, in a direction toward the base 22 to be placed into the folded configuration illustrated in FIG. 8 and may be pivoted in a direction away from the base 22 to be placed in the unfolded configuration. The top rails 36 may each be placed into the folded configuration after the middle rails 38 are folded or pivoted into the folded configuration, such that the middle rails 38 rest between the top rails 36 and the mast 12 in the folded configuration.

The platforms 34 may each be pivoted about two bolts, one extending through each of the pivotable straps 52 of the platforms 34, in a direction away from the base 22 to be placed into the folded configuration illustrated in FIG. 8 and may be pivoted in a direction toward the base 22 to be placed in the unfolded configuration. The platform 34 may be placed into its folded configuration after the top rails 36, such that both the top rails 36 and the middle rails 38 rest between the platform 34 and the mast 12.

The lower ladder support 145 and/or the middle ladder support 147 may also be pivoted about two bolts, one extending through each of the first and second mast attachment plates 146,148, in a direction away from the base 22 to be placed into the folded configuration illustrated in FIG. 8 and may be pivoted in a direction toward the base 22 to be placed in the unfolded configuration. The attachment strip 142 may be bolted to the retaining tab 156 when the lower ladder support 145 is in the folded configuration.

The F-brackets 136 that are fixedly attached to the platform assemblies 14,16 in the unfolded configuration may remain fixedly attached in both the folded and the unfolded configurations of the MLP assembly 10. Alternatively, the F-brackets 136 may be unbolted from the platform assemblies 14,16 and banded thereto for transport and then bolted to the appropriate platform support angle 54 at the installation site. In some embodiments of the invention, the F-bracket bolted to the top rail 36 of the upper platform assembly 16 may be unbolted therefrom in the folded configuration and then bolted thereto along with one of the vertical supports 40 in the unfolded configuration, while the F-brackets 136 bolted to the platforms 34 may remain bolted thereto in both the folded and unfolded configurations.

Once all of the MLP assembly components are in the folded configuration, the ladders 18,20 and the vertical supports may be stacked onto the folded MLP assembly 10 and banded thereto, as described above and illustrated in FIG. 9. Additionally, any other components unbolted from the MLP assembly 10 in the folded configuration may be stacked onto and banded to the folded MLP assembly 10. Bolts and any other small loose components required to fix the MLP assembly 10 in its unfolded configuration may be stored in the electrical box 158 or otherwise temporarily attached to the MLP assembly 10 for transport.

Additionally, the temporary base frame 94 may be attached to the base plate 90 by bolting the diagonal support strip to the base plate 90. The temporary base frame 90 may be attached such that the first base stacking bracket 24 is on an opposite side of the mast 12 than the platform assemblies 14,16 and the second base stacking bracket 26 is on the same side of the mast 12 as the platform assemblies 14,16.

Once the MLP assembly 10 is in the folded configuration, it may be loaded on a vehicle for transportation to an installation site. The MLP assembly 10 may be stacked on top of other MLP assemblies and/or may have other MLP assemblies stacked on top of it, as illustrated in FIG. 9. For example, a first base stacking bracket of a first MLP assembly may rest on top of a second base stacking bracket of a second MLP assembly, and a first top stacking bracket of the first MLP assembly may rest on top of a second top stacking bracket of the second MLP assembly. In one example, four MLP assemblies are stacked on top of each other in the folded configuration on a trailer or flatbed truck to be transported to one or more installation sites.

When the MLP assembly 10 is unloaded at the installation site, it may be unloaded and placed on the ground in a horizontal orientation on the first base stacking bracket 24 and the first top stacking bracket 28, as illustrated in FIG. 8, thereby keeping all other components of the MLP assembly 10 off of the ground. This allows easy access to all components of the MLP assembly 10 and keeps critical components of the MLP assembly 10 out of the mud or other undesirable ground conditions. The stacking brackets 24-30 may further comprise or be loaded onto slide plates (not shown) for easy loading and unloading into trucks or containers.

To install the MLP assembly 10, an individual may cut or unbind the ladders 18,20, F-brackets 136, and/or the vertical supports 40 from the mast 12. Then the top ladder support 145 may be unbolted from the retaining tab 156 and pivoted to a substantially 90° angle relative to the center axis of the mast 12, as illustrated in FIGS. 10-11. Additionally, in some embodiments of the invention, the middle ladder support 147 may be unattached from one of the mast attachment plates 125 and pivoted to a substantially 90° angle relative to the center axis of the mast 12. Once the lower and/or middle ladder supports 145,147 are in the unfolded configuration, at least one or two additional bolts may be inserted through holes in the first mast attachment plate 146 and extend through corresponding holes in the first ladder support plate 152 to fixedly secure the lower and/or middle ladder supports 145,147 in the unfolded configuration.

Furthermore, the platforms 34 may be pivoted to a substantially 90° angle relative to the center axis of the mast 12 about bolts extending through the pivotable straps 52 of the platform 34 and through the corresponding first and second mast attachment straps 130,132, as illustrated in FIGS. 10-12. The pivot limiting tabs 134 may prevent the platforms 34 from rotating further than 90°. Then at least one additional bolt may be inserted through one or more holes of at least one of the pivotable straps 52 of the platforms 34 and extend through corresponding holes in the corresponding first and/or second mast attachment straps 130,132 to fixedly secure the platforms 34 in the unfolded configuration.

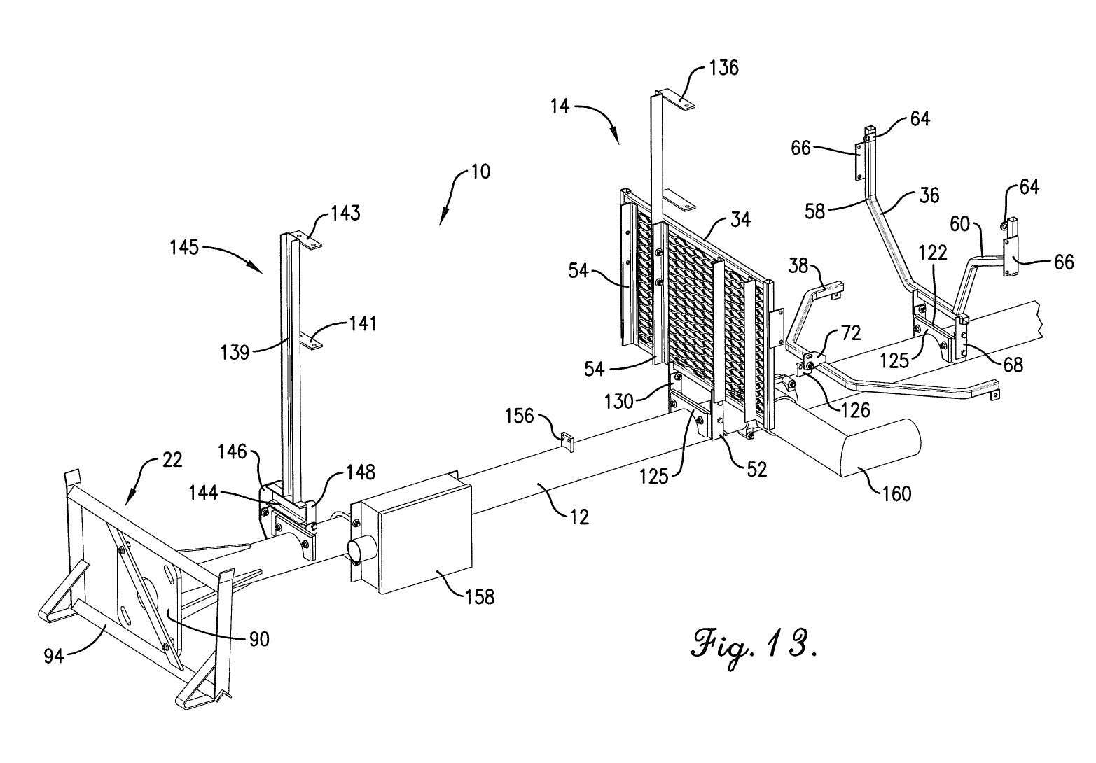

Then, as illustrated in FIG. 13, the top rails 36 may be pivoted to a substantially 90° angle relative to the center axis of the mast 12 and be fixed in that unfolded position by the insertion of at least one additional bolt through one or more holes of at least one of the pivotable straps 68 of the top rails 36. The additional bolt or bolts may also extend through corresponding holes in the corresponding first and/or second mast attachment straps 130,132 to fixedly secure the top rails 36 in the unfolded configuration.

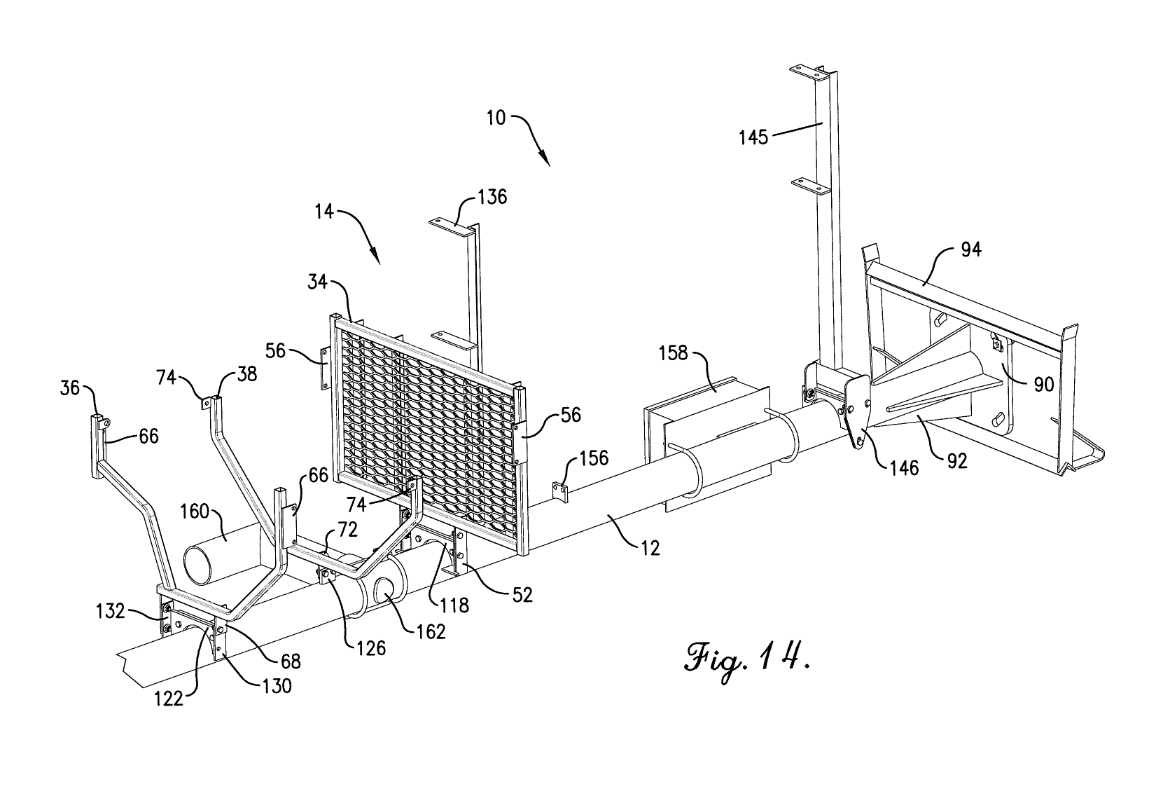

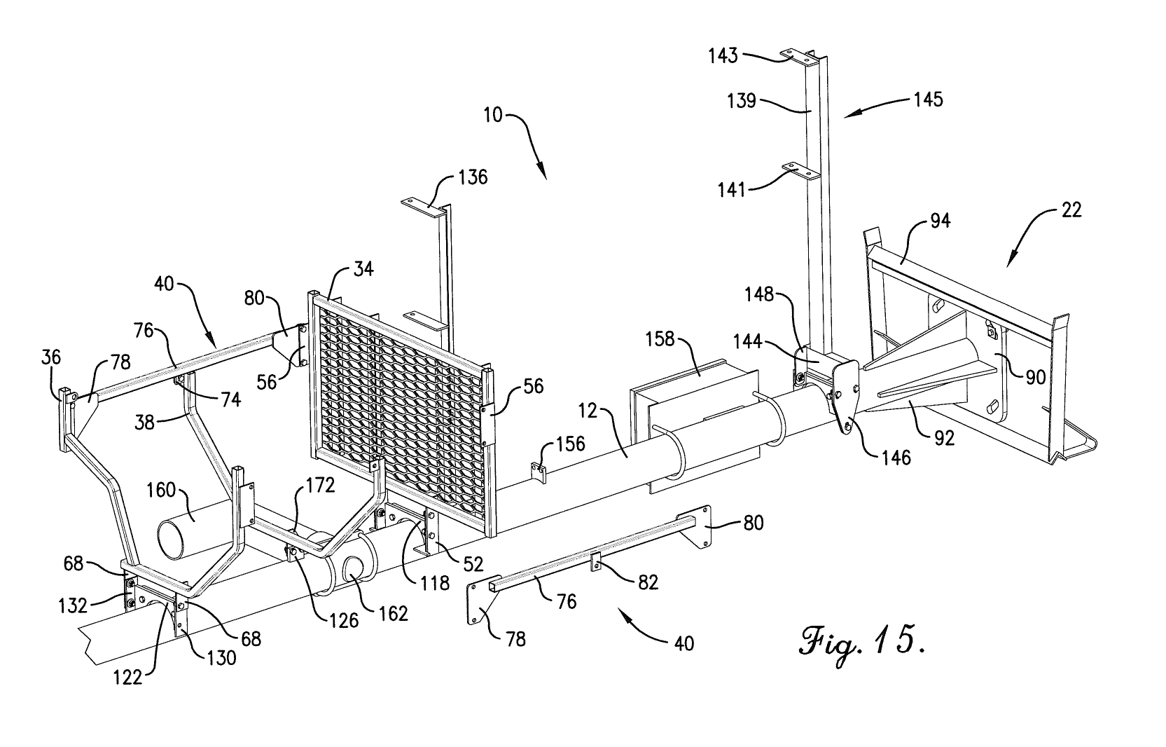

Next, as illustrated in FIGS. 14-15, the middle rails 38 may be pivoted to a substantially 90° angle relative to the center axis of the mast 12 and be fixed in that unfolded position by the insertion of at least one additional bolt through holes of each of the mast attachment tabs 72 of the middle rails 38 and corresponding holes in the corresponding middle rail-mast attachment tabs 126,128 extending from the mast 12. In some embodiments of the invention, the additional bolts are not required, since attachment to the vertical supports 40 substantially fixes the middle rails 38 in the unfolded configuration.

The vertical supports 40 may each then be bolted to one or more of the platforms 34, top rails 36, and middle rails 38, as illustrated in FIG. 15. For example, the vertical support attachment straps 56,66 may be fixedly bolted to the upper and lower vertical support plates 78,80 and the middle rail attachment tabs 82 may be fixedly bolted to the vertical support attachment plates 74 of the middle rails 38. Simultaneously, one of the F-brackets 136 may be bolted to one of the vertical supports 40 and the top rail 36 of the upper platform assembly 16 by placing one or more bolts through holes in the F-bracket, corresponding holes in the vertical support attachment straps 66 and corresponding holes in the upper vertical support plate 78.

Next, one of the ladders 18,20 may be bolted to at least one of the F-brackets 136, the lower ladder support 145, and/or the middle ladder support 147. For example, a first ladder 18 may be attached to the lower ladder support 145 and/or the F-bracket attached to the middle platform assembly 14, and a second ladder 20 may be attached to the one or two F-brackets 136 attached to the upper platform assembly 16, as illustrated in FIGS. 1-2. In an alternative embodiment of the invention, the first ladder 18 may be attached to the lower ladder support 145 and/or the middle ladder support 147, as illustrated in FIGS. 3-4. Then the first and second ladders 18,20 may be bolted together to form a single ladder. Alternatively, a single ladder may be used. However, the use of two or more ladders may be advantageous for allowing a single individual to install the ladders 18,20 onto the MLP assembly 10.

Once the ladders 18,20 and the vertical supports 40 are fixedly bolted into place in the unfolded configuration, the MLP assembly 10 may be reoriented from its horizontal orientation to its vertical orientation, as illustrated in FIGS. 1-4. For example, one or more individuals, a crane, and/or other lifting equipment may be attached to the MLP assembly 10 and may actuate it from the horizontal to the vertical orientation. In one embodiment of the invention, the crane may be attached at or proximate a top end of the mast 12 and may lift the MLP assembly 10. For example, the crane may be hooked to a cord or strap wrapped around the mast 12 and/or the bracket extensions 116. The crane may lift the MLP assembly 10 in a direction such that the MLP assembly 10 pivots relative to the ground or installation surface on its rocker straps 106,108 from the horizontal to the vertical orientation as it is being lifted by the crane. Once in the vertical orientation, the MLP assembly 10 may continue to be lifted slightly above the ground or installation surface such that the temporary base frame 94 may be removed from the base 22, such as by unbolting the diagonal support strip 104 therefrom.

The crane may then lower the MLP assembly 10 onto the ground or an installation surface such that the base plate 90 may be anchored thereto using bolts or any other mechanical fasteners required, as illustrated in FIGS. 1-4. In some embodiments of the invention, the bottom ladder support (not shown) may be bolted to a bottom end of one of the ladders 18,20 closest to the ground and the bottom ladders support may be at least partially buried in the ground to further anchor the ladders 18,20. Then the crane and/or the stacking brackets 28,30 may also be removed from the MLP assembly 10.

The method and MLP assembly 10 described herein provides a variety of advantages over prior art MLP assemblies. For example, the stacking bracket arrangement may allow 16 MLP assenblies to be shipped on one flatbed truck, with the MPL assemblies stacked 4 high. In contrast, only about 5-8 prior art MLP assemblies could be shipped on one flatbed truck. Furthermore, the stacking brackets 24-30 may be unbolted from the MLP assembly 10 and reused. The MLP assembly 10 does not require external packing materials or crates and may be shipped as one complete, self-contained unit. The temporary base frame 94 provides a wider base for stabilizing the mast 12 while lifting, such that the MLP assembly 10 may be prevented from rolling. The top stacking brackets 28,30 and their corresponding bracket extensions 116 may also provide a secure place to attach lifting cords or straps (not shown) for reorienting the MLP assembly 10 from the horizontal to the vertical orientation.

Further advantages of the MLP assembly include the platform 34 and rails 36,38 being formed of tubes, which reduce twist and provide greater stability and strength than angle rails or rigid strap frames used in prior art MLP assemblies. Also, because most of the assembly takes place prior to shipment of the MLP assembly 10, one individual can assemble the MLP assembly 10 at the installation site in approximately one third of the time it would take a typical 5-person crew to assemble the prior art MLP assembly at the installation site.

Although the invention has been described with reference to the preferred embodiment illustrated in the attached drawing figures, it is noted that equivalents may be employed and substitutions made herein without departing from the scope of the invention.

Having thus described various embodiments of the invention, what is claimed as new and desired to be protected by Letters Patent includes the following:

1. A mast ladder platform (MLP) assembly comprising:
an elongated mast having a base configured to be fixed to a ground support at one end thereof;
a platform assembly attachable to the mast and movable between a folded configuration and an unfolded configuration; and
a ladder fixable to the platform assembly.

2. The MLP assembly of claim 1, wherein the platform comprises:
a platform that is substantially perpendicular to the mast when the platform assembly is in the unfolded configuration and substantially parallel with the mast when the platform assembly is in the folded configuration;
a rail that is substantially perpendicular to the mast when the platform assembly is in the unfolded configuration and substantially parallel with the mast when the platform assembly is in the folded configuration; and
a vertical support configured to fixedly attach to the platform and the rail when the platform assembly is in the unfolded configuration.

3. The MLP assembly of claim 1, wherein the rail is a top rail, the MLP further comprising a middle rail attachable to the mast between the top rail and the platform.

4. The MLP assembly of claim 3, wherein the middle rail is configured to pivot away from the base into the folded configuration, the top rail is configured to pivot toward the base into the folded configuration, and the platform is configured to pivot away from the base into the folded configuration.

5. The MLP assembly of claim 1, further comprising F-brackets extending outward from the platform assembly, wherein the F-brackets are fixed to the at least one ladder when the platform assembly is in the unfolded configuration.

6. The MLP assembly of claim 1, further comprising a ladder support attached to the mast between the platform assembly and the base, wherein the ladder support extends substantially perpendicular to the mast in an unfolded configuration and is configured to be fixed to the at least one ladder in an unfolded configuration, wherein the ladder support is pivotable away from the base to a folded configuration in which the ladder support is substantially parallel with the mast.

7. The MLP assembly of claim 1, further comprising a plurality of stacking brackets fixed to the mast, wherein portions of the stacking brackets are shaped to mate with other stacking brackets, such that a plurality of MLP assemblies, identical to the MLP assembly of claim 1 and each comprising the stacking brackets, are stackable, one on top of the other, such that the stacking brackets of the MLP assembly are vertically aligned with the stacking brackets of the plurality of MLP assemblies.

8. The MLP assembly of claim 6, wherein the stacking brackets comprise a first base stacking bracket, a second base stacking bracket, a first top stacking bracket, and a second top stacking bracket, wherein the first base stacking bracket and the first top stacking bracket each comprise elongated channels angled away from the mast and the second base stacking bracket and the second top stacking bracket each comprise elongated channels angled toward the mast.

9. The MLP assembly of claim 7, wherein the first base stacking bracket and the second base stacking bracket are positioned substantially perpendicular relative to the mast and the first top stacking bracket and the second top stacking bracket are positioned substantially parallel relative to the mast.

10. A mast ladder platform (MLP) assembly comprising:
an elongated mast having a base end and a top end opposite the base end;
a first base stacking bracket attached to the mast at or proximate to the base end;
a second base stacking bracket attached to the mast at or proximate to the base end;
a first top stacking bracket attached to the mast at or proximate to the top end; and
a second top stacking bracket attached to the mast at or proximate to the top end;
wherein the first base stacking bracket and the first top stacking bracket each comprise elongated channels angled away from the mast and the second base stacking bracket and the second top stacking bracket each comprise elongated channels angled toward the mast.

11. The MLP assembly of claim 10, wherein the first base stacking bracket and the second base stacking bracket are positioned substantially perpendicular relative to the mast and the first top stacking bracket and the second top stacking bracket are positioned substantially parallel relative to the mast.

12. The MLP assembly of claim 10, wherein the mast is an elongated pole having a substantially cylindrical shape.

13. The MLP assembly of claim 10, wherein the first and second base stacking brackets and the first and second top stacking brackets are each attached to and spaced apart from the mast by bracket extensions.

14. The MLP assembly of claim 10, further comprising:
a platform assembly attached to the mast and movable between a folded configuration and an unfolded configuration; and
a ladder fixable to the platform assembly when the platform assembly is in the unfolded configuration.

15. A method of transporting and installing a mast ladder platform (MLP) assembly, the method comprising:
placing the MLP assembly onto a vehicle in a generally horizontal orientation, with stacking brackets of the MLP assembly supporting a mast and a platform assembly of the MLP assembly on the vehicle;
transporting the MLP assembly to an installation site via the vehicle;
removing the MLP assembly from the vehicle;
placing the MLP assembly in a generally horizontal orientation onto the ground, such that the stacking brackets support the mast and the platform assembly above the ground;
pivoting portions of the platform assembly from a folded configuration to an unfolded configuration;
lifting the MLP assembly from the horizontal orientation into a generally vertical orientation; and
fixing a base of the MLP assembly relative to the ground.

16. The method of claim 15, further comprising fixing a ladder to the platform assembly when the platform assembly is in the unfolded configuration.

17. The method of claim 16, further comprising pivoting a ladder support located between the base of the MLP assembly and the platform assembly from a folded configuration to an unfolded configuration relative to the mast and fixing the ladder to the ladder support.

18. The method of claim 15, wherein the platform assembly comprises:
a platform substantially parallel with the mast in the folded configuration and substantially perpendicular to the mast in the unfolded configuration; and
a rail substantially parallel with the mast in the folded configuration and substantially perpendicular to the mast in the unfolded configuration.

19. The method of claim 15, wherein a temporary base frame is attached to the base of the MLP assembly until after the MLP assembly is lifted from the generally horizontal orientation into the generally vertical orientation, the temporary base frame having a greater width than a width of the base of the MLP assembly.

20. The method of claim 19, further comprising removing the temporary base frame from the base before fixing the base of the MLP assembly relative to the ground.

21. The method of claim 15, further comprising stacking an additional MLP apparatus onto the MLP apparatus on the vehicle, prior to the step of transporting the MLP apparatus, such that stacking brackets of the additional MLP apparatus are vertically aligned with stacking brackets of the MLP apparatus on the vehicle.

22. The method of claim 15, further comprising fixing the platform assembly in the unfolded configuration.
